(19) United States
(12) Patent Application Publication
(10) Pub. No.: US 2025/0250367 A1
(43) Pub. Date: Aug. 7, 2025

(54) METHOD OF PRODUCING ETHYLENE-BASED COPOLYMER

(71) Applicants: SK INNOVATION CO., LTD., Seoul (KR); SK GEO CENTRIC CO., LTD., Seoul (KR)

(72) Inventor: Ho Seong LEE, Daejeon (KR)

(21) Appl. No.: 19/044,280

(22) Filed: Feb. 3, 2025

(30) Foreign Application Priority Data
Feb. 1, 2024 (KR) 10-2024-0015515

(51) Int. Cl. C08F 2/01; C08F 2/00; C08F 120/06; C08K 5/08

(52) U.S. Cl. CPC C08F 2/01; C08F 2/001; C08F 120/06; C08K 5/08; C08F 2400/02

(57) ABSTRACT

In a method of producing an ethylene-based copolymer according to the embodiments of the present disclosure, a monomer solution including a comonomer and monomethyl ether hydroquinone is discharged into a reactor through a first discharge unit. An ethylene monomer reacts with the comonomer by injecting the ethylene monomer into the reactor. A content of the monomethyl ether hydroquinone in the monomer solution is adjusted to be 210 ppm or more based on a total weight of the comonomer.

### CROSS-REFERENCE TO RELATED APPLICATIONS

This application claims priority under 35 U.S.C. § 119 to Korean Patent Application No. 10-2024-0015515, filed on Feb. 1, 2024, the disclosure of which is incorporated herein by reference in its entirety.

### BACKGROUND

### 1. Field of the Invention

The embodiments of the present disclosure relate generally to a method of producing an ethylene-based copolymer.

### 2. Description of the Related Art

An ethylene-based copolymer is utilized for various applications such as a sealing material, an adhesive, a packing material, an optical film and the like. For example, the ethylene-based copolymer may include an ethylene-carboxylic acid copolymer, an ethylene-acrylate copolymer, and an ethylene-(alkyl) acrylate copolymer.

The ethylene-based copolymer may be produced by polymerizing ethylene and another monomer (referred to as a comonomer), such as, for example carboxylic acid, acrylate, etc., through a continuous reactor.

However, self-polymerization may occur when the ethylene or the comonomer is exposed to high temperature or pressure when they are supplied to a reactor through a flow path, a pump, a compressor and the like.

When the ethylene monomer and/or the comonomer are self-polymerized, equipment defects such as clogging, plugging, and flow path blocking of the above-described monomer introduction equipment may occur. Therefore, the production yield of the ethylene-based copolymer may be decreased and it may be difficult to uniformly repeat the process.

Methods of using a solvent or an additive together to suppress the self-polymerization of the monomers may be considered. However, side reactions may occur due to the solvent, and molecular weight adjustment may be limited due to a chain transfer performance inherent in the solvent. In order to directly block the above-described equipment defects, an improved solution that efficiently suppresses the self-polymerization of the ethylene monomer and/or the other comonomer is required.

### SUMMARY

Embodiments of the present disclosure provide a method of producing an ethylene-based copolymer for implementing improved process reliability and polymerization efficiency.

According to an embodiment of the present disclosure, there is provided a method of producing an ethylene-based copolymer including discharging a monomer solution including a comonomer and monomethyl ether hydroquinone into a reactor through a first discharge unit; and reacting an ethylene monomer with the comonomer by injecting the ethylene monomer into the reactor, wherein a content of the monomethyl ether hydroquinone in the monomer solution is 210 ppm or more based on a total weight of the comonomer.

In an embodiment, the content of the monomethyl ether hydroquinone in the monomer solution may be 210 ppm or more and less than 2,000 ppm based on the total weight of the comonomer.

In an embodiment, the operation of reacting an ethylene monomer with the comonomer may include discharging the ethylene monomer into the reactor through a second discharge unit.

In an embodiment, the monomer solution and the ethylene monomer are introduced into the reactor through different paths, respectively.

In an embodiment, the monomer solution may be supplied from the first discharge unit to the reactor through a first discharge flow path, and the ethylene monomer may be supplied from the second discharge unit to the reactor through a second discharge flow path.

In an embodiment, a temperature in the first discharge unit and the first discharge flow path may be a crystallization temperature or higher of the comonomer.

In an embodiment, the temperature in the first discharge flow path may be adjusted within a range of Inequality expression 1 below:

$$P + 500 ° C . < 54.002 \times T < P + 3400 ° C . \qquad Inequality expression 1$$

In the inequality expression 1, P is a discharge pressure of the first discharge unit measured in units of bar, and T is the temperature in degrees Celsius in the first discharge flow path.

In an embodiment, a pressure in the first discharge unit may be 1,500 bar to 3,000 bar.

In an embodiment, the operation of reacting an ethylene monomer with the comonomer may include injecting the ethylene monomer from the second discharge unit into the reactor after the monomer solution is supplied from the first discharge unit to the reactor.

In an embodiment, the comonomer may include a carboxylic acid monomer or an acrylate monomer.

In an embodiment, the carboxylic acid monomer may include acrylic acid or methacrylic acid.

In an embodiment, the method may further include supplying a lubricant composition into the first discharge unit.

According to the embodiments of the present disclosure, by using the monomethyl ether hydroquinone together with the comonomer, generation of a self-polymer of the comonomer (e.g., polyacrylic acid (PAA) may be suppressed. Accordingly, a production yield of the copolymer may be improved, and clogging of polymerization equipment may be suppressed.

According to an embodiment of the present disclosure, the monomethyl ether hydroquinone may be included in an amount of 210 ppm or more and less than 2,000 ppm. Accordingly, even if the comonomer is discharged under high temperature and high pressure conditions, a condition where self-polymerization does not occur may be stably maintained, and polymerization reactivity of the ethylene monomer and the comonomer may be improved.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIG. 1 is a schematic process flowchart for describing a method of producing an ethylene-based copolymer according to an embodiment of the present disclosure;

FIG. 2 is a graph illustrating the crystallization temperature of a comonomer (acrylic acid) used in the making of the ethylene-based copolymer as a function of the pressure;

FIG. 3 is a schematic process flowchart for describing a method of producing an ethylene-based copolymer according to an embodiment of the present disclosure;

FIG. 4A is a graph illustrating changes in the temperature and pressure of an ultra-high pressure cell in Example 1;

FIG. 4B is a graph illustrating changes in the temperature and pressure of an ultra-high pressure cell in Example 2;

FIG. 4C is a graph illustrating changes in the temperature and pressure of an ultra-high pressure cell in Comparative Example 1;

FIG. 5A is a cross-sectional image of the ultra-high pressure cell captured 10 minutes after reaching the target temperature and pressure in Comparative Example 1;

FIG. 5B is an image of a PAA self-polymer acquired from the ultra-high pressure cell of Comparative Example 1;

FIG. 6A is a graph illustrating changes in the temperature and pressure of the ultra-high pressure cell in Example 1; and

FIG. 6B is a graph illustrating changes in the temperature and pressure of a ultra-high pressure cell in Comparative Example 2.

### DETAILED DESCRIPTION

Various embodiments of the present disclosure provide a method of producing an ethylene-based copolymer, which includes ethylene monomer with a comonomer and prevents self-polymerization of the comonomer or of the ethylene.

Various embodiments of the present disclosure provide a method of producing an ethylene-based copolymer which includes pumping a comonomer through a discharge unit, and preventing self-polymerization of the comonomer.

Various embodiments of the present disclosure provide a method of producing an ethylene-based copolymer which includes pumping an ethylene monomer and a comonomer through different discharge units, and preventing self-polymerization of the comonomer.

The term “(meth)acrylic acid” as used herein is used to mean both acrylic acid and methacrylic acid. The term “(meth)acrylate” as used herein is used to mean both acrylate and methacrylate.

Hereinafter, embodiments of the present disclosure will be described in more detail with reference to specific experimental examples, drawings and the like. However, the following drawings attached to the present specification illustrate preferred embodiments of the present disclosure and serve to further describe the technical concepts and implementations of the present disclosure. Furthermore, the embodiments should not be construed as being limited only to the illustrations of the drawings.

FIG. 1 is a schematic process flowchart for describing a method of producing an ethylene-based copolymer according to an embodiment of the present disclosure.

Referring to FIG. 1, a comonomer may be supplied from a first monomer supply unit 10 to a first discharge unit 20.

A first monomer solution may be discharged from the first discharge unit 20. The first discharge unit 20 may include discharge equipment such as a pump, a compressor, etc.

The first monomer solution includes a comonomer and monomethyl ether hydroquinone. The first monomer solution may not include an ethylene monomer.

The comonomer may include a carboxylic acid comonomer or an acrylate comonomer of which a chain polymerization reaction is possible.

In an embodiment, (meth)acrylic acid may be used as the carboxylic acid comonomer. In an embodiment, (meth)acrylate or alkyl (meth)acrylate may be used as the acrylate comonomer.

A mixture of the comonomer and monomethyl ether hydroquinone may be delivered from the first monomer supply unit 10 to the first discharge unit 20 through a first flow path 22.

The monomethyl ether hydroquinone may be included as a component that inhibits self-polymerization between the comonomer molecules. For example, a self-polymerization of the comonomer may be suppressed even under conditions of high temperature and high pressure due to an interaction between the monomethyl ether hydroquinone and the comonomer.

For example, an active radical may be generated from the comonomer (for example, the acrylic acid) under conditions of high temperature and high pressure. The monomethyl ether hydroquinone has a relatively high reactive activity for the active radical, and may easily supply and transfer hydrogen to the active radical. Accordingly, the active radical may be stabilized.

In addition, the radical formed by removing hydrogen from the monomethyl ether hydroquinone may not substantially react with the comonomer, and thus the first monomer solution may be stabilized.

A content of the monomethyl ether hydroquinone in the first monomer solution is 210 ppm or more based on a total weight of the comonomer. Accordingly, even if the first monomer solution is discharged under high temperature and high pressure conditions, the radical of the comonomer may be consumed within a short period of time by the monomethyl ether hydroquinone. Therefore, the self-polymerization may be effectively suppressed.

For example, if the content of the monomethyl ether hydroquinone is less than 210 ppm, a reaction frequency between the monomethyl ether hydroquinone and the active radical may be substantially reduced. For example, a rate at which the active radical is consumed by the monomethyl ether hydroquinone may be reduced, such that a reaction between the active radical and the comonomer may be further promoted. Accordingly, the self-polymerization of the comonomer may be initiated and propagated by the active radical.

According to an embodiment of the present disclosure, the content of the monomethyl ether hydroquinone in the first monomer solution may be less than 2,000 ppm. For example, the content of the monomethyl ether hydroquinone may be 210 ppm or more and less than 2,000 ppm based on the total weight of the comonomer.

For example, when the content of the monomethyl ether hydroquinone is 2,000 ppm or more, the monomethyl ether hydroquinone may exist in an excessively high concentration within the polymerization system. Accordingly, a copolymerization reaction of the ethylene monomer and the comonomer may be inhibited, thereby causing a reduction in the process efficiency and a deterioration in the yield of the ethylene-based copolymer.

In an embodiment, the content of the monomethyl ether hydroquinone in the first monomer solution may be 250 ppm to 2,000 ppm, 400 ppm to 1,500 ppm, 450 ppm to 1,000 ppm, or 450 ppm to 800 ppm based on a total weight of the carboxylic acid comonomer. Within the above range, the self-polymerization of the comonomer may be effectively suppressed, as well as the yield of the ethylene-based copolymer may be further increased.

The first monomer solution may be discharged from the first discharge unit 20 through a first discharge flow path 24 for copolymerization with, for example, the ethylene monomer. For example, the first monomer solution pumped or discharged from the first discharge unit 20 may be supplied to a reactor 50 through the first discharge flow path 24.

In an embodiment, the first discharge unit 20 may include a piston and a packing part. The packing part may be a sealing member such as a bushing, a cylinder, etc. The first monomer solution may be discharged through a relative reciprocating motion and/or rotational motion of the piston and the packing part.

In an embodiment, a pressure (e.g., a discharge pressure) in the first discharge unit 20 may be 1,500 bar to 3,000 bar. The first monomer solution may be compressed by the first discharge unit 20 and rapidly supplied to the reactor 50.

In an embodiment, the discharge pressure may be 1,500 bar to 2,500 bar, or 1,800 bar to 2,300 bar.

In an embodiment, temperatures (e.g., discharge temperatures) in the first discharge unit 20 and the first discharge flow path 24 may be a crystallization temperature or more of the comonomer.

For example, the discharge temperature may be adjusted within a range of the inequality expression 1 below.

$$P + 500 < 54.002 \times T < P + 3400 \qquad Inequality expression 1$$

In the inequality expression 1, P is a discharge pressure of the first discharge unit measured in units of bar, and T is the temperature (C) in the first discharge flow path.

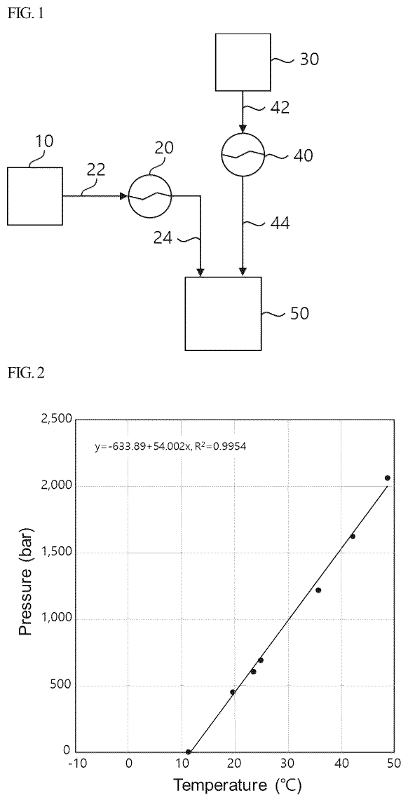

In an example, as the discharge pressure is increased, the crystallization temperature of the comonomer may be increased. FIG. 2 is a graph illustrating the crystallization temperature of a comonomer (acrylic acid) according to the discharge pressure.

Referring to FIG. 2, as the discharge pressure is increased, the crystallization temperature of the comonomer may be increased. For example, the crystallization temperature of acrylic acid is about 48° C. at a pressure of about 2,000 bar. Therefore, as the discharge pressure is increased, the acrylic acid may be crystallized even at a relatively high discharge temperature.

When the discharge temperature is the crystallization temperature or lower of the comonomer, the comonomer may be crystallized, such that the first monomer solution may not be pumped or discharged to the reactor 50. In this case, clogging of a gap or the discharge flow path inside the first discharge unit 20 may occur, such that a replacement cycle or cleaning cycle of the device may be shortened.

However, the higher the discharge temperature, the easier it becomes for the activation energy required for the dehydrogenation of the comonomer to be satisfied. As a result, as the discharge temperature increases the concentration of the active radical may be increased. Accordingly, the self-polymerization of the comonomer by the active radical may be increased.

To address this issue, according to an embodiment of the present disclosure, the first monomer solution may include 210 ppm or more of monomethyl ether hydroquinone, such that the active radical may be consumed quickly. Thereby, even at an increased discharge temperature, the concentration of the active radicals can be maintained low, and, as a result both crystallization and self-polymerization of the comonomer may be suppressed.

In an embodiment, the following inequality expression 1 may be satisfied: P+500<54.002×T≤P+3000, P+550≤54.002×T≤P+2800, or P+550≤54.002×T≤P+2000.

In an embodiment, the temperatures (e.g., the discharge temperatures) in the first discharge unit 20 and the first discharge flow path 24 may be 45° C. or higher. Within the above temperature range, the possibility of crystallization of the comonomer may be substantially reduced.

In an embodiment, the temperatures (e.g., the discharge temperatures) in the first discharge unit 20 and the first discharge flow path 24 may be 100° C. or lower. Within the above temperature range, the possibility of self-polymerization of the comonomer may be substantially reduced.

In an embodiment, the discharge temperature may be 45° C. to 100° C., 48° C. to 90° C., 60° C. to 90° C., or 60° C. to 85° C. Within the above range, a stable discharge process may be continuously maintained without crystallization and self-polymerization of the comonomer even if increasing the discharge pressure.

According to an embodiment of the present disclosure, the first monomer solution may not include a solvent. For example, the first monomer solution may be a solvent-free type in which the comonomer acts as a medium.

In an example, when the monomer solution includes a solvent, the density or concentration of the comonomer may be decreased, thereby reducing a reaction between the active radical and the comonomer.

However, in this case, a side reaction between the comonomer and the solvent may occur, and properties of the copolymer may be changed due to the side reaction. In addition, since the solvent has inherent chain transfer properties, it may be difficult to adjust the molecular weight of the copolymer, and a copolymer having a molecular weight within a desired range may not be acquired.

For example, since the first monomer solution includes 210 ppm or more of monomethyl ether hydroquinone, the reactivity between the active radical and the monomethyl ether hydroquinone may be improved even if it does not include the solvent. Accordingly, the active radical may be rapidly consumed in the first monomer solution, and the self-polymerization of the comonomer may be effectively suppressed.

In an embodiment, a lubricant composition may be supplied together with the first monomer solution into the first discharge unit 20. The lubricant composition may include a mineral oil. In an embodiment, the lubricant composition may further include a self-polymerization inhibitor such as a phenothiazine compound.

Even when the phenothiazine compound is included in a small amount or not included as described above, the formation of the self-polymer (e.g., polyacrylic acid “PAA”) by the above-described monomethyl ether hydroquinone may be sufficiently suppressed.

A second monomer solution stored in a second monomer supply unit 30 may be moved to a second discharge unit 40 through a second flow path 42. For example, the second monomer solution may be a solvent-free type in which the second monomer acts as a medium.

For example, the first monomer solution and the second monomer solution may be introduced into the reactor 50 through different paths 24, and 44, respectively. The second monomer solution may come into contact with the first monomer in the reactor 50 to be copolymerized.

Since the first monomer is discharged through a separate discharge unit from the second monomer, discharge conditions (pressure, temperature, etc.) of the first monomer and the second monomer may be respectively adjusted.

For example, in the second discharge unit 40 which discharges the second monomer, a relatively high pressure is required. Thus, when the comonomer is supplied through the second discharge unit 40, equipment defects such as clogging, plugging, and flow path blocking, etc. may occur.

The second monomer solution may include an ethylene monomer in a supercritical state. For example, the second monomer solution may be composed of an ethylene monomer in a supercritical state. As a non-limiting example, the second monomer solution may be mixed with the first monomer solution, a polymerization initiator, and/or a chain transfer agent before being injected into the reactor. For example, the second monomer solution may be mixed with a polymerization initiator, and/or a chain transfer agent after being injected into the reactor.

The second monomer may include an ethylene monomer. For example, when ethylene is used as the ethylene monomer, copolymerization of the comonomer and ethylene may be performed within the reactor 50 to produce an ethylene-based copolymer.

For example, when a carboxylic acid monomer is used as the comonomer, an ethylene-carboxylic acid copolymer, for example, an ethylene acrylic acid (“EAA”) copolymer may be produced. For example, when an acrylate monomer is used as the comonomer, an ethylene-acrylate copolymer and/or an ethylene-(alkyl) acrylate copolymer may be produced.

In an embodiment, the second monomer solution 30 may be discharged from the second discharge unit 40 to be injected into the reactor 50 through the second discharge flow path 44. The first monomer solution and the second monomer solution may be supplied into the reactor 50 through different discharge flow paths 24, and 44, respectively, thereby preventing copolymerization from initiating or being promoted within the discharge flow path.

In an embodiment, a polymerization initiator may be introduced into the reactor 50 together through the second discharge flow path 44 or through a separate flow path. Accordingly, the self-polymerization of the comonomer may be prevented from being promoted first.

For example, initiators known in the field of polymer polymerization may be used as the polymerization initiator. For example, peroxide or a peroxy compound, an azobis compound, etc. may be used as the polymerization initiator.

In an embodiment, a chain transfer agent may be introduced during the polymerization process, for example, through the second discharge flow path 44. The molecular weight and molecular weight distribution of a polymer product may be easily controlled within a desired range through the chain transfer agent.

The chain transfer agent may include, for example, a nonpolar organic compound such as isobutane, propene, etc., or a polar organic compound such as methyl ethyl ketone, isopropylaldehyde, or vinyl acetate, etc.

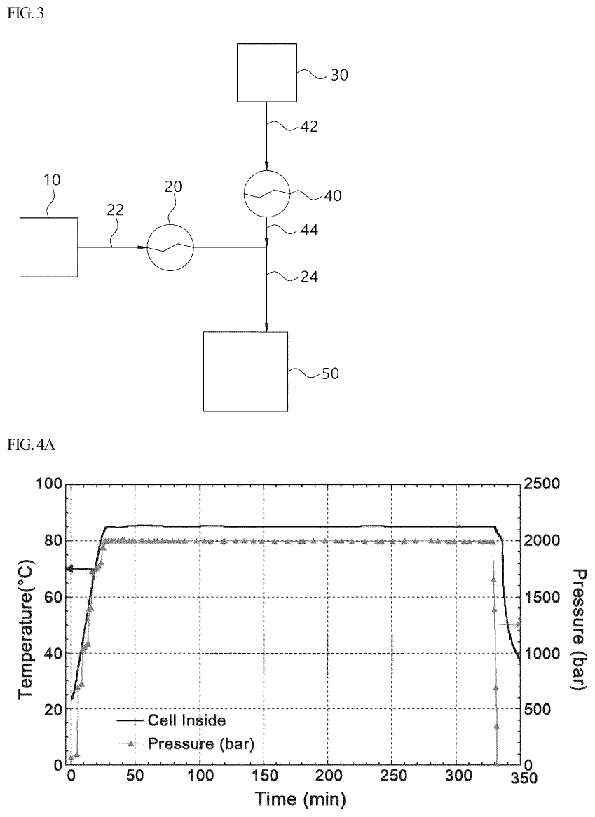

FIG. 3 is a schematic process flowchart for describing a method of producing a copolymer according to an embodiment of the present disclosure.

Referring to FIG. 3, the first monomer solution and the second monomer solution may be supplied through the same discharge flow path. For example, both the first discharge unit 20 and the second discharge unit 40 may be connected to the first discharge flow path 24.

In an embodiment, the monomer solution and the ethylene monomer may be introduced into the reactor through different paths, respectively.

In an embodiment, the method may comprise discharging an ethylene monomer and a monomer solution from separate discharge units; supplying the ethylene monomer and the monomer solution to a same flow path; and injecting a mixture of the ethylene monomer and the monomer solution into a reactor.

In an embodiment, the monomer solution and the ethylene monomer may be each discharged from different discharge units, supplied to a same discharge flow path through different discharge flow paths, mixed, and introduced into the reactor through the same discharge flow path.

In an embodiment, the monomer solution may be supplied from the first discharge unit to the reactor through a first discharge flow path, and the ethylene monomer may be supplied from the second discharge unit to the first discharge flow path through a second discharge flow path, and may be supplied to the reactor through the first discharge flow path.

In an embodiment, the monomer solution may be supplied from the first discharge unit to the reactor through a first discharge flow path, and the ethylene monomer may be supplied from the second discharge unit to the first discharge flow path through a second discharge flow path, and may be supplied to the reactor through the first discharge flow path.

The first monomer solution may be supplied from the first discharge unit 20 to the reactor 50 through the first discharge flow path 24. the second monomer solution may be injected into the reactor 50 from the second discharge unit 40 through a second discharge flow path 44 and a first discharge flow path 24 in sequence.

In an embodiment, the second monomer solution 30 may be discharged from the second discharge unit 40 to the second discharge flow path 44, and then supplied from the second discharge flow path 44 to the first discharge flow path 24, before being injected into the reactor 50 through the first discharge flow path 24.

The first monomer solution and the second monomer solution may be supplied into the reactor 50 through the same discharge flow paths 24.

In an embodiment, the first monomer solution may be supplied from the first discharge unit 20 to the reactor 50 through the first discharge flow path 24. With this type of configuration, the supply of the first monomer solution may be blocked, and the second monomer solution may be injected into the reactor 50 from the second discharge unit 40 through the first discharge flow path 24.

Accordingly, in this way, the first monomer solution and the second monomer solution may be prevented from coming into contact with each other before being introduced into the reactor 50. Therefore, clogging of the first discharge flow path 24 may be prevented, and fouling and a reduction in the process efficiency due to ethylene-based copolymer may be suppressed.

In an embodiment, the temperature in the reactor 50 may be higher than the temperature in the first discharge unit 20. For example, the temperature in the reactor 50 may be about 150° C. to 270° C.

In an embodiment, the pressure in the reactor 50 may be 1100 bar to 2500 bar, or 1300 bar to 2300 bar. In an embodiment, the pressure in the reactor 50 may be lower than the discharge pressure in the second discharge unit 40.

The ethylene-based copolymer produced by the method according to the above-described embodiments may be applied to various fields such as a sealing material, an adhesive, a packing material, an optical film and the like. For example, the ethylene-based copolymer may be applied to the surface of a polymer film, a paper sheet, a metal foil, fabrics, etc., to be provided as a packaging material for food or a coating material for food.

Hereinafter, experimental examples including specific examples and comparative examples are proposed to facilitate understanding of the embodiments of the present disclosure. However, the following examples are only given for illustrating the embodiments and are not intended to limit the appended claims. It will be apparent those skilled in the art that various alterations and modifications are possible within the scope and technical concepts of the present disclosure, and such alterations and modifications are duly included in the appended claims. Furthermore, the embodiments may be combined to form additional embodiments.

### Experimental Example 1

### Example 1

A monomer solution was prepared by mixing acrylic acid (AA) (99% purity, manufactured by Sigma-Aldrich) with 500 ppm of monomethyl ether hydroquinone (MeHQ).

The monomer solution was filled into an ultra-high pressure view cell (manufactured by Dong-A University), and the target temperature and pressure were set to be 85° C. and 2,000 bar, respectively. A generation of a self-polymer was observed while aging at the target temperature and pressure.

It was evaluated that the self-polymer was generated at the point when the temperature and pressure of the ultra-high pressure cell are rapidly decreased.

### Example 2

The generation of the self-polymer was observed by the same evaluation method as in Example 1, except that the content of the monomethyl ether hydroquinone (MeHQ) was changed to 700 ppm.

### Comparative Example 1

The generation of the self-polymer was observed by the same evaluation method as in Example 1, except that the content of the monomethyl ether hydroquinone (MeH IQ) was changed to 200 ppm.

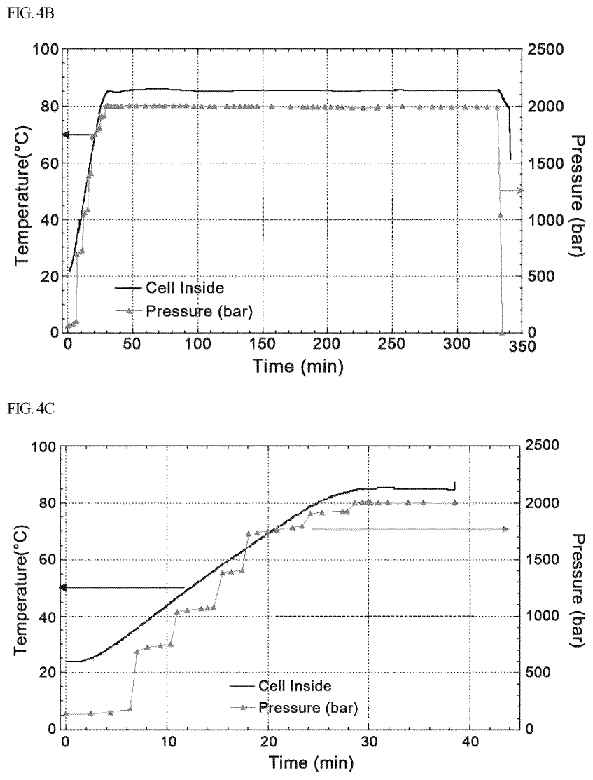

FIG. 4A is a graph illustrating changes in the temperature and pressure of an ultra-high pressure cell in Example 1. FIG. 4B is a graph illustrating changes in the temperature and pressure of an ultra-high pressure cell in Example 2. FIG. 4C is a graph illustrating changes in the temperature and pressure of an ultra-high pressure cell in Comparative Example 1.

Referring to FIGS. 4A to 4C, in Examples 1 and 2, the self-polymer was generated about 5 hours after reaching the target temperature and pressure. In Examples 1 and 2, the monomer solution was maintained in a stable state at the target temperature and pressure for about 5 hours.

However, in Comparative Example 1, the self-polymer was generated about 10 minutes after reaching the target temperature and pressure.

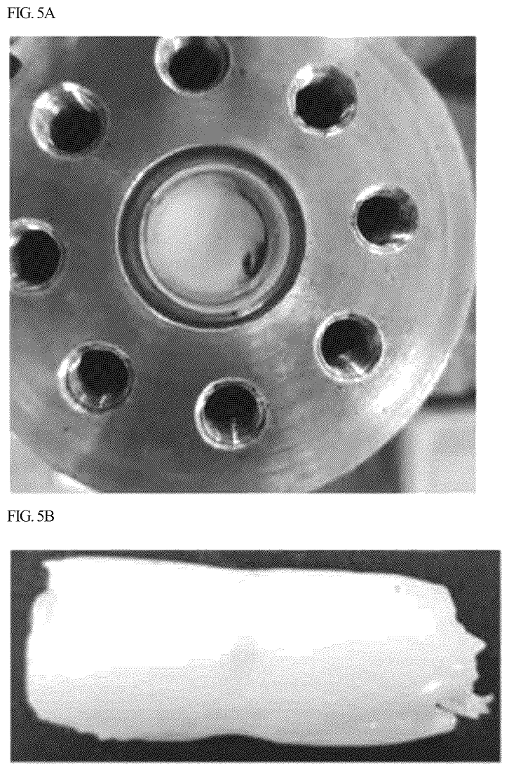

FIG. 5A is a cross-sectional image of the ultra-high pressure cell captured 10 minutes after reaching the target temperature and pressure in Comparative Example 1. FIG. 5B is an image of a PAA self-polymer acquired from the ultra-high pressure cell of Comparative Example 1. Referring to FIGS. 5A and 5B, in Comparative Example 1, the PAA polymer was formed within a short period of time, thereby causing plugging in the gap and flow path of the ultra-high pressure cell.

### Experimental Example 2

### Example 3

The generation of the self-polymer was observed by the same evaluation method as in Example 1, except that the target temperature and pressure were set to be 100° C. and 2,000 bar, respectively.

### Comparative Example 2

The generation of the self-polymer was observed by the same evaluation method as in Example 1, except that the target temperature and pressure were set to be 65° C. and 2,000 bar, respectively.

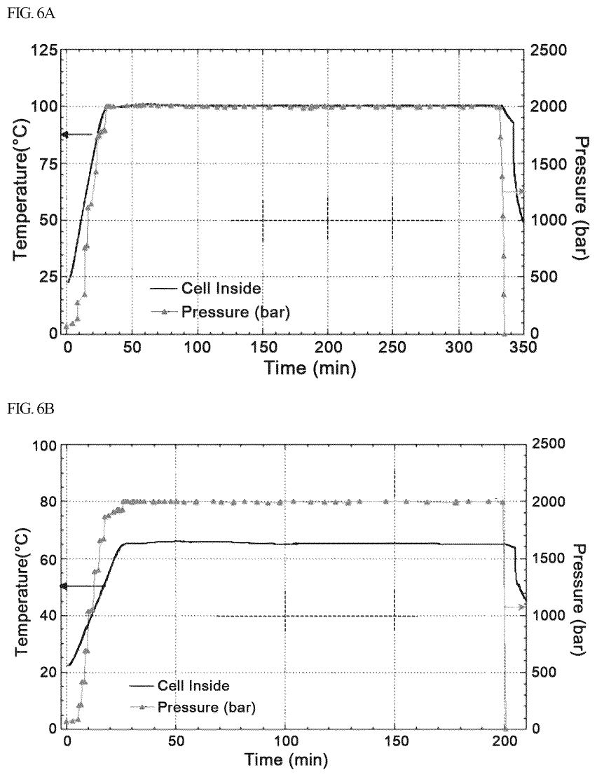

FIG. 6A is a graph illustrating changes in the temperature and pressure of the ultra-high pressure cell in Example 1. FIG. 6B is a graph illustrating changes in the temperature and pressure of a ultra-high pressure cell in Comparative Example 2

Referring to FIGS. 6A and 6B, in Example 3, even if the target temperature was increased to 100° C., the monomer solution was maintained in a stable state for about 5 hours. However, in Comparative Example 2, even though the target temperature was decreased to 65° C., the self-polymer was generated before 3 hours had passed since reaching the target temperature and pressure.

### Experimental Example 3

A monomer solution was prepared by mixing acrylic acid (AA) (99% purity, manufactured by Sigma-Aldrich) with monomethyl ether hydroquinone (MeHQ).

The monomer solution was filled into an ultra-high pressure view cell (manufactured by Dong-A University), and the target temperature and pressure were set to be 85° C. and 2,000 bar, respectively. Aging was performed for 5 hours at the target temperature and pressure. The content of the monomethyl ether hydroquinone (MeHQ), target temperature and pressure were adjusted as described in Table 1 below.

The content of MeHQ before aging and the content of MeHQ after aging were measured using high performance liquid chromatography (HPLC). When the MeHQ content was not measured, it was indicated as “-,” and when it was measured to be less than 10 μm/g, it was indicated as “<10” in Table 1.

Liquid chromatography analysis was performed using Shimadzu's LC-10AD, and a C-18 column was used for measurement under a solvent condition of acetonitrile:methanol=4:1 (v/v).

When PAA polymerization is performed in the monomer solution, MeHQ is consumed, such that the frequency of PAA polymerization can be confirmed through a residual amount of the MeHQ.

The contents of acrylic acid dimer (AA dimer) before and after aging were measured using gas chromatography (GC). When the AA dimer content was not measured, it was indicated as “-”, and when it was measured to be less than 0.1 wt %, it was indicated as “<0.1” in Table 1.

Gas chromatography analysis was performed using Agilent's 6890A, and FID detector and DB-5 column (60 m×0.32 mm×1.0 μm) were used for measurement.

In the process of aging the monomer solution, acrylic acid monomers form AA dimers. When performing the PAA polymerization reaction, the AA dimer may be converted to PAA, such that the content of the AA dimer may be decreased. Therefore, the frequency of an occurrence of the PAA polymerization reaction may be confirmed through the residual amount of the AA dimer.

TABLE 1

| | MeHQ | | | MeHQ (μm/g) | | AA dimer (wt %) | |
|---|---|---|---|---|---|---|---|
| | Content | Pressure | Temperature | Before | After | Before | After |
| Division | (ppm) | (bar) | (° C.) | aging | aging | aging | aging |
| Example 1 | 500 | 2000 | 85 | 502 | 488 | <0.1 | 25.44 |
| Example 2 | 700 | 2000 | 85 | 701 | 691 | <0.1 | 9.08 |
| Example 3 | 500 | 2000 | 100 | 535 | 569 | <0.1 | 70.74 |
| Example 4 | 700 | 2000 | 100 | 703 | 699 | <0.1 | 66.97 |
| Example 5 | 1000 | 2000 | 85 | 1,054 | 1,081 | <0.1 | 12.3 |
| Example 6 | 1000 | 2000 | 100 | 1,023 | 995 | <0.1 | 68.61 |
| Comparative | 200 | 2000 | 85 | 198 | — | <0.1 | — |
| Example 1 | | | | | | | |
| Comparative | 200 | 2000 | 65 | 203 | <10 | <0.1 | 2.23 |
| Example 2 | | | | | | | |

Refaning to Table 1 above, in the examples, MeHIQ was not substantially consumed in the monomer solution in the aging process. In addition, the content of AA dimer was increased after aging.

However, in the comparative examples, MoHIQ was consumed in the aging process, such that only a relatively small amount thereof remained. In addition, the AA dimer was not measured or was measured in a small amount after aging

What is claimed is:

1. A method of producing an ethylene-based copolymer, the method comprising:
discharging a monomer solution including a comonomer and monomethyl ether hydroquinone into a reactor through a first discharge unit; and
reacting an ethylene monomer with the comonomer by injecting the ethylene monomer into the reactor,
wherein a content of the monomethyl ether hydroquinone in the monomer solution is 210 ppm or more based on a total weight of the comonomer.

2. The method of producing an ethylene-based copolymer according to claim 1, wherein the content of the monomethyl ether hydroquinone in the monomer solution is 210 ppm or more and less than 2,000 ppm based on the total weight of the comonomer.

3. The method of producing an ethylene-based copolymer according to claim 1, wherein reacting the ethylene monomer with the comonomer comprises discharging the ethylene monomer into the reactor through a second discharge unit.

4. The method of producing an ethylene-based copolymer according to claim 3, wherein the monomer solution and the ethylene monomer are introduced into the reactor through different paths, respectively.

5. The method of producing an ethylene-based copolymer according to claim 4, wherein the monomer solution and the ethylene monomer are each discharged from different discharge units, supplied to a same discharge flow path through different discharge flow paths, mixed, and introduced into the reactor through the same discharge flow path.

6. The method of producing an ethylene-based copolymer according to claim 5, wherein a temperature in the first discharge unit and the first discharge flow path is a crystallization temperature or higher of the comonomer.

7. The method of producing an ethylene-based copolymer according to claim 6, wherein the temperature in the first discharge flow path is adjusted within a range according to the inequality expression 1:
$$P + 500 ° C . < 54.002 \times T < P + 3400 ° C . \qquad Inequality expression 1$$
wherein in the inequality expression 1, P is a discharge pressure of the first discharge unit measured in units of bar, and Tis the temperature in degrees Celsius in the first discharge flow path.

8. The method of producing an ethylene-based copolymer according to claim 6, wherein a pressure in the first discharge unit is 1,500 bar to 3,000 bar.

9. The method of producing an ethylene-based copolymer according to claim 3, wherein the temperature in the reactor is higher than the temperature in the first discharge unit.

10. The method of producing an ethylene-based copolymer according to claim 1, wherein the comonomer comprises a carboxylic acid monomer or an acrylate monomer.

11. The method of producing an ethylene-based copolymer according to claim 10, wherein the carboxylic acid monomer comprises acrylic acid or methacrylic acid.

12. The method of producing an ethylene-based copolymer according to claim 1, further comprising supplying a lubricant composition into the first discharge unit.

13. The method of producing an ethylene-based copolymer according to claim 12, wherein the lubricant composition includes a mineral oil.

14. The method of producing an ethylene-based copolymer according to claim 12, wherein the lubricant composition further includes a self-polymerization inhibitor.

15. A method of producing an ethylene-based copolymer, the method comprising:
discharging an ethylene monomer and a monomer solution from separate discharge units;
supplying the ethylene monomer and the monomer solution to a same flow path; and
injecting a mixture of the ethylene monomer and the monomer solution into a reactor, and
wherein the monomer solution includes monomethyl ether hydroquinone in an effective amount to prevent self-polymerization of the comonomer.

16. The method of producing an ethylene-based copolymer according to claim 15, wherein the content of the monomethyl ether hydroquinone in the monomer solution is 210 ppm or more and less than 2,000 ppm based on the total weight of the comonomer.

17. The method of producing an ethylene-based copolymer according to claim 1, wherein the discharging of the ethylene monomer and the monomer solution includes using different discharge units.
